(19) United States
(12) Patent Application Publication
(10) Pub. No.: US 2024/0324627 A1
(43) Pub. Date: Oct. 3, 2024

(54) USE OF A FEED ADDITIVE IN LOW ENERGY FEED FOR PIGS

(71) Applicant: Alzchem Trostberg GmbH, Trostberg (DE)

(72) Inventors: Peter LOIBL, Waging am See (DE); Judith RINGEL, Laer (DE)

(73) Assignee: Alzchem Trostberg GmbH, Trostberg (DE)

(21) Appl. No.: 18/700,092

(22) PCT Filed: Oct. 10, 2022
(86) PCT No.: PCT/EP2022/078059

§ 371 Date: Apr. 10, 2024

(30) Foreign Application Priority Data
Oct. 13, 2021 (DE) 10 2021 126 581.9

(51) Int. Cl. A23K 20/142; A23K 20/105; A23K 50/30

(52) U.S. Cl. CPC A23K 20/142; A23K 20/105; A23K 50/30

(57) ABSTRACT

The present invention relates to the use of a composition comprising guanidinoacetic acid in the fattening of pigs with a low energy feed for improving the energy utilization of the feed by the pigs, wherein the low energy feed has an energy content in the range of 11.4 to 12.9 MJ ME/kg during fattening of the pigs.

The present invention relates to the use of a composition comprising guanidinoacetic acid in the fattening of pigs with a low energy feed. Furthermore, the invention relates to a method for improving the energy utilization of a low energy feed by pigs by adding guanidinoacetic acid and to a feed for pigs comprising a low energy feed and guanidinoacetic acid. The optimization of feeds can be carried out from many points of view. On the one hand, all the nutrients that an animal needs must be available in sufficient quantities in the feed. In addition to the nutrient requirements, animal health is another factor that determines an optimal feed composition. Numerous other factors, such as environmental aspects, regulations on fertilization during feed production and emissions, must also be taken into account. Feeding plays a central role in all these requirements for livestock, in particular for fattening pigs.

Various feed additives are now used to meet the requirements of modern feed. First and foremost, deficiencies in the feed mixture are compensated for by the targeted addition of essential and growth-limiting nutrients. Exemplary, essential amino acids such as lysine or methionine, calcium and other metal salts or vitamins are mentioned. However, flavorings or endogenous substances that influence cell metabolism are also used. In contrast to poultry, the use of creatine or guanidinoacetic acid in pig fattening has played a rather subordinate role to date. Guanidinoacetic acid (syn. glycocyamine, N-guanylglycine, N-amidinoglycine; C₃H₇N₃O₂; CAS No. 352-97-6) has been commercially available as a feed additive for some time in poultry feed.

In contrast to creatine or creatine monohydrate, guanidinoacetic acid and its salts exhibit significantly higher stability in acidic aqueous solution and are only converted into creatine under physiological conditions. Guanidinoacetic acid is converted into creatine only after absorption, in particular in the liver. Thus, in contrast to creatine, the majority of the administered or fed compounds, guanidinoacetic acid and/or salts of guanidinoacetic acid, is not degraded by instability reactions, e.g. in the stomach, but is actually available for the corresponding physiological metabolic reactions.

For example, WO 2005/120246 A1 describes that supplementation of the precursor compound of creatinyl phosphate, namely with guanidinoacetic acid, in predominantly vegetarian diets contributes to improving feed intake, increasing fattening performance, muscle meat gain, meat quality and/or reproductive performance in chickens.

WO 2006/092298 A1 describes salts of guanidinoacetic acid which exhibit increased water solubility or bioavailability.

The use of guanidinoacetic acid in pig fattening to reduce caudophagy or to reduce the aggressiveness of pigs is disclosed in WO 2021/175677 A1.

In a study by Weber et al. (published in A. Zeyner, H. Kluth, M. Bulang, M. Bochnia und M. Bachmann (Hrsg.), 14. Tagung Schweine und Geflügelernährung, 21.-23. November 2017, Lutherstadt Wittenberg, Institut für Agrar- und Ernährungswissenschaften, Universität Halle-Wittenberg), the influence of guanidinoacetic acid in a common feed is investigated. The study found a slight improvement in feed conversion, but only a slight daily increase at the threshold of significance. According to the study, the addition of guanidinoacetic acid to high energy feed showed a slightly lower feed uptake in pigs. The effect of guanidinoacetic acid on the energy utilization of pigs, in particular when using low energy feed, was not investigated by Weber et al.

High energy components of feed are often only available in limited quantities compared to low energy components. Reducing the energy content while maintaining the same performance could therefore make it possible to feed animals in a more resource-efficient manner. However, a reduction in the energy content of the ration usually leads to an increase in feed intake, which usually negates the benefits of a low energy diet or even further increases the consumption of resources per kg of weight gain.

In summary, there is not yet an economical method to fully compensate for the disadvantages of a low energy diet for pigs.

It is therefore an object of the present invention to provide a feed additive for pigs which, when low energy feed is fed, significantly increases the weight of the animals at the end of fattening compared to feeding a low energy feed alone, and preferably achieves the weight obtained when feeding a balanced high energy feed.

This object is solved by a use according to claim 1. Thus, according to a first embodiment, the use of i) a composition comprising guanidinoacetic acid and ii) a low energy feed for pigs having a crude protein content in the range of 10.0 to 20.0 wt. % (based on the total weight of the feed) and an energy content in the range of 11.4 to 12.9 MJ ME/kg feed (based on the total weight of the feed) during fattening of the pigs from a live weight of ≥ 27 kg per pig, for improving the energy utilization of the feed by the pigs, is subject matter of the present invention.

Energy utilization is defined as the amount of metabolizable energy (metabolic energy ME) that leads to a weight gain of the animal of one kilogram. An improvement in energy utilization is therefore defined by a reduction in the ratio of the metabolic energy of the feed consumed per kilogram of weight gain of the animal.

The wording “based on the total weight of the feed” or “based on the total feed” means that the corresponding values refer to a feed with 88% dry matter.

When the term guanidinoacetic acid is used in the following, it refers not only to the free acid, but also to its salts, unless the text explicitly refers to the free acid.

The present invention relates in particular to the use of guanidinoacetic acid in the fattening of pigs, wherein a composition comprising guanidinoacetic acid and a low energy feed is used. According to the present invention, a low energy feed is to be understood as a feed which preferably has a crude protein content in the range of 14.0 to 18.0 wt. % (based on the total feed) and an energy content of 11.4 to 12.9 MJ ME/kg.

The crude protein content is determined using the VDLUFA method for determining crude protein (VDLUFA Methodenbuch III, 3. Erg. 1993: Rohprotein, 4.1.1). The nitrogen content of the feed is determined by means of sulphuric acid digestion, distillation and titration of the ammonia released. Protein contains an average of 16% nitrogen. The crude protein content is therefore determined by multiplying the nitrogen content by 6.25.

The metabolizable energy (ME) content of the feed is calculated using the following formula (Gesellschaft für Ernährungsphysiologie, 2008: Prediction of metabolisable energy of compound feeds for pigs. Proceedings of the Society of Nutrition Physiology 17, 199-204):

$$ME ( MJ / kg ) = 0.021503 ( MJ / g ) \times XP ( g / kg ) + 0.032497 ( MJ / g ) \times XL ( g / kg ) - 0.021071 ( MJ / g ) \times crude fiber ( g / kg ) + 0.016309 ( MJ / g ) \times starch ( g / kg ) + 0.014701 ( MJ / g ) \times “ digestible residue ” ( g / kg )$$

The formula therefore contains the analyzed contents of crude protein (XP), digestible crude fat (XL), crude fiber, starch and the “digestible residue” (difference between the organic mass and the sum of XP, XL, crude fiber and starch, each in g/kg).

In commercially available feed, the crude protein content, the crude fat content, the crude fiber content and the starch content are usually indicated, so that the content of metabolizable energy can be calculated directly. The crude protein content, the crude fat content, the crude fiber content and the starch content can also be determined using common VDLUFA methods (VDLUFA Methodenbuch III: 3. Erg. 1993, Abschnitt 4.1.1 (Rohproteinbestimmung); 2. Erg. 1988, Abschnitt 5.1.1 (Rohfettbestimmung; 8. Erg. 2012, Abschnitt 7.2.1 (Stärkebestimmung); 3. Erg. 1993, Abschnitt 6.1.1 (Rohfaserbestimmung)).

It is further provided that the composition comprising guanidinoacetic acid and the low energy feed is used during fattening of the pigs from a live weight of ≥27 kg, preferably of ≥50 kg, particularly preferably of over 60 kg per pig (hereinafter also referred to as the fattening phase). Thus, the use according to the invention takes place outside the first growth phase of the piglets up to a weight of 27 kg per pig (hereinafter also referred to as breeding) and preferably also outside the pre-fattening of the pigs, which in the sense of the present invention is characterized by a live weight of up to 60 kg per pig (hereinafter also referred to as pre-fattening).

According to the present invention, a composition comprising guanidinoacetic acid is used.

Surprisingly, feeding experiments in pigs have now shown that the administration of a composition containing guanidinoacetic acid leads to the desired benefit, namely to achieve a fattening performance when feeding low energy feed that could otherwise only be achieved with a high energy feed. The feeding study has shown that a difference in energy content of 0.3 MJ ME/kg feed can be fully compensated for by the addition of guanidinoacetic acid. Preferably, an energy deficit of 0.1 MJ ME/kg feed and more, particularly preferably of 0.1-0.5 MJ ME/kg feed and very particularly preferably of 0.2-0.4 MJ ME/kg feed is compensated by the use of guanidinoacetic acid.

Another surprising finding was that the compensation of the energy content of the feed only became fully visible in the fattening phase. The use of guanidinoacetic acid in this phase led to an improvement in energy utilization compared to a negative control group with the same analytical energy content. This means that less feed or metabolizable energy was required to achieve at least the same or even a higher fattening performance. Fattening performance is defined here as the increase in body mass per day. The groups supplied with guanidinoacetic acid even achieved a performance level that was better than that of a positive control group supplied with significantly more energy. Although guanidinoacetic acid itself has no significant energy content, improving the supply of guanidinoacetic acid to the animals, and thus also creatine, can compensate for an energy deficit in the feed.

The use of guanidinoacetic acid in low energy feed to improve the energy utilization of the feed by pigs in order to compensate for an energy deficit of at least 0.1 MJ ME/kg compared to a corresponding feed without guanidinoacetic acid is therefore a further subject matter of the present invention, as is the use of guanidinoacetic acid in low energy feed to improve the energy utilization of the feed by pigs compared to the low energy feed alone.

According to the present invention, it is provided that the low energy feed for the pigs has a crude protein content of 10.0 to 20.0 wt. %, preferably 14.0 to 18.0 wt. %. According to a further preferred use, it is provided that the low energy feed for the pigs has a crude protein content of at least 14.5 wt. %, even more preferably of at least 15.0 wt. %, even more preferably of at least 15.6 wt. %, particularly preferably of at least 16.0 wt. % and very particularly preferably of at least 16.2 wt. % (based on the total weight of the feed). At the same time or independently thereof, the low energy feed for the pigs may have a crude protein content of at most 17.8 wt. %, more preferably of at most 17.6 wt. %, even more preferably of at most 17.4 wt. % and particularly preferably of at most 17.2 wt. % (based on the total weight of the feed).

Thus, according to a further preferred use, it is provided that the low energy feed for the pigs has a crude protein content in the range from 15.0 to 17.8 wt. %, more preferably in the range of 15.6 to 17.8 wt. %, even more preferably in the range of 16.0 to 17.8 wt. % and even more preferably in the range of 16.2 to 17.8 wt. % (based on the total weight of the feed). Even more preferred is a feed which has a crude protein content in the range of 16.8 to 17.6 wt. % and very particularly preferably of 17.2±0.2 wt. % (based on the total weight of the feed).

According to the present invention, it is provided that the feed has an energy content of 11.4 to 12.9 MJ ME/kg based on the total feed. According to a preferred use, it is provided that the low energy feed for pigs used has an energy content of at least 11.4 MJ ME/kg, more preferably of at least 11.8 MJ ME/kg, even more preferably of at least 12.0 MJ ME/kg, even more preferably of at least 12.2 MJ ME/kg and very particularly preferably of at least 12.4 MJ ME/kg (in each case based on the total weight of the feed). At the same time or independently thereof, the low energy feed for the pigs can have an energy content of at most 12.9 MJ ME/kg, more preferably at most 12.8 MJ ME/kg, and very particularly preferably of at most 12.7 MJ ME/kg (in each case based on the total feed).

Thus, according to a further preferred use, it is provided that the low energy feed for pigs has an energy content in the range of 12.0 to 12.8 MJ ME/kg (based on the total feed), more preferably in the range from 12.2 to 12.8 MJ ME/kg, even more preferably in the range of 12.4 to 12.8 MJ ME/kg, even more preferably in the range of 12.6 to 12.8 MJ ME/kg and very particularly preferably from 12.7±0.05 MJ ME/kg (in each case based on the total feed).

The use of guanidinoacetic acid in combination with low energy feed is particularly beneficial in the fattening phase, as soon as the pigs have reached a weight of 60 kg. The administration of guanidinoacetic acid is particularly beneficial up to a weight of 110 kg. However, the use of guanidinoacetic acid can also improve the energy utilization of the animals beyond this, even if the protein requirement in the diet of the animals decreases with increasing age and weight. Guanidinoacetic acid can also be administered in the pre-fattening stage, when the animals weigh approximately 27-60 kg, to support energy utilization.

It has been shown that the use of guanidinoacetic acid according to the invention is not limited to the substance as such. Rather, both guanidinoacetic acid as such, namely as a free acid, or also a salt of guanidinoacetic acid can be used.

Particularly preferably, a salt selected from the group of alkali metal or alkaline earth metal salts of guanidinoacetic acid can be used as the salt. Very particularly preferably, sodium guanidinoacetate, potassium guanidinoacetate, magnesium guanidinoacetate or calcium guanidinoacetate can be used.

However, the use of a composition containing guanidinoacetic acid as free acid is particularly preferred, and a composition containing only the free acid and not its salts is particularly preferred.

The guanidinoacetic acid-containing composition is preferably used as a solid in powder or granular form, but can also be used in the form of an aqueous solution, as pastilles, capsules, pellets or jelly. For the purposes of the present invention, a composition containing guanidinoacetic acid is also to be understood as the use of guanidinoacetic acid as a pure substance without further additives.

The composition comprising guanidinoacetic acid may contain further nutritionally active substances, for example from the series of carbohydrates, fats, amino acids, proteins, vitamins, minerals, trace elements, methyl group donors and derivatives of these substances and mixtures thereof. Preferably, the composition contains amino acids, in particular lysine, methionine, threonine, tryptophan and valine. Furthermore, the composition may contain vitamins, such as vitamin A, vitamin D3, vitamin E, nicotinic acid, nicotinic acid amide and β-carotene. The above-mentioned substances can of course also be added directly to the feed.

Preferably, guanidinoacetic acid is used in the form of granules containing at least one binder. Suitable binders include, in particular, nutritionally active substances that have a binding effect and enable good granulation of the composition, such as glycine, starch or sugar. Other suitable binders are, for example methylcellulose, ethylcellulose, carboxymethylcellulose, carboxyethylcellulose, carboxypropylcellulose, hydroxypropylmethylcellulose, hydroxymethylcellulose, microcrystalline cellulose, ethylmethylcellulose and other cellulose derivatives, hydroxypropyl starch, pregelatinized or modified starch, sugar syrup, dextrin, gelatine, propylvinyl alcohol, polyvinylpyrrolidone, xanthan, gum arabic, sodium chloride, sodium carbonate, sodium hydrogen carbonate and glycerol and mixtures thereof. To improve the flowability of the granules, it may be advantageous for them to contain a flow aid, in particular a hydrophilic and/or hydrophobic silica and/or silicate-based additives and/or fatty acids and/or their salts, such as stearic acid or palmitic acid and their sodium, potassium and calcium salts.

The binder is preferably present in amounts of 0.05 to 15 wt. %, in particular 0.1 to 1.5 wt. % in the granulated guanidinoacetic acid composition. The particle size of suitable granules is preferably between 100 and 850 μm, with preferably less than 10 wt. % of the particles being below 100 μm and less than 10 wt. % of the particles being above 850 μm. Accordingly, the mouldings preferably have a content of guanidinoacetic acid or guanidinoacetic acid salts of 85 to 99.95 wt. %, in particular 95 to 98.5 wt. %. Flow agents and other additives may be present in the granules in an amount of up to 5 wt. %.

Preferably, guanidinoacetic acid is used in an amount of at least 0.01 wt. %, more preferably of at least 0.02 wt. %, further preferably of at least 0.03 wt. % and very particularly preferably of at least 0.04 wt. %. The upper limit for the guanidinoacetic acid used is preferably 0.20 wt. %, more preferably at most 0.15 wt. %, more preferably at most 0.12 wt. %, particularly preferably at most 0.10 wt. % and very particularly preferably at most 0.08 wt. % (based on the total weight of the feed).

According to a preferred embodiment of the use according to the invention, it is therefore provided that the guanidinoacetic acid is used in an amount of from 0.01 to 0.20 wt. %, preferably from 0.02 to 0.15 wt. % and particularly preferably from 0.04 to 0.10 wt. % (in each case based on the total weight of the low energy feed).

According to a preferred embodiment of the invention, it may be provided that the use is such that the composition comprising guanidinoacetic acid is provided as a solid preparation mixed with the low energy feed for the pigs. Further preferably, the composition is provided as a solid preparation mixed with the low energy feed for the pigs, wherein the composition contains the guanidinoacetic acid in an amount of from 0.01 to 0.20 wt. %, preferably from 0.02 to 0.15 wt. % and particularly preferably from 0.04 to 0.10 wt. % (based on the total weight of the feed).

According to a further preferred embodiment of the invention, the use is such that the composition is provided as a solid preparation mixed with the low energy feed for the pigs, wherein the composition comprises guanidinoacetic acid in an amount of 0.03 to 0.08 wt. % (based on the total weight of the feed).

According to the present invention, a low energy feed is used that is adjusted with respect to the parameters crude protein and energy content in accordance with the ranges described herein. This low energy feed can comprise a basic feed and further feed additives. It has been shown that particularly good results can be achieved if the low energy feed comprises as basic feed a) at least one vegetable component, in particular a grain, a grain flour, a grain meal, a grain extraction meal, a grain semolina, a grain bran or a grain semolina bran, and b) a fat or oil of vegetable or animal origin. Further preferred is a use in which the basic feed comprises at least one vegetable component selected from groups a1) to a6), in particular a grain, a grain flour, a grain semolina, a grain meal, a grain extraction meal, a grain bran or a grain semolina bran and/or an oilseed product and b) animal or vegetable fat and/or oil, wherein:
a1) wheat, wheat flour, wheat semolina, wheat meal, wheat bran, wheat semolina bran thereof,
a2) barley, barley flour, barley meal, barley bran thereof,
a3) corn, corn flour, corn meal thereof,
a4) soy, soy flour, soy meal or a soy extraction meal thereof,
a5) rapeseed, rapeseed flour, rapeseed meal or rapeseed meal extraction thereof, and/or
a6) sunflower, sunflower flour, sunflower meal or a sunflower extraction meal thereof.

Further feed additives can be added to this basic feed. In particular, the low energy feed can comprise a further feed additive from the group of minerals, amino acids, vitamins, trace elements or mixtures thereof. Very particularly preferably, this feed additive can be selected from the group of lysine, methionine, threonine, tryptophan, valine and vitamins as well as mixtures thereof. Furthermore, creatine or methyl group donors such as methionine, betaine and choline can also be added to the feed.

Many of these ingredients are added to the feed in the form of a mixture (premix), in particular to ensure that the animals have an adequate supply of essential nutrients.

Preferred low energy feeds include
a) at least one carbohydrate-rich component selected from the group consisting of wheat, wheat meal, barley, barley meal, corn and corn meal; and
b) a protein-rich component selected from the group of oilseeds, such as soy, soy meal, soy extraction meal, rapeseed, rapeseed meal, rapeseed extraction meal, sunflower, sunflower meal and sunflower extraction meal; and
c) optionally a low energy component selected from the group of branes, in particular wheat bran, wheat semolina bran, barley bran and corn bran; and
d) a fat selected from the group of animal or vegetable fats and oils.

The proportion of carbohydrate-rich components in the preferred low energy feeds is usually between 30 and 90 wt. %, particularly preferably in the range of 40 to 80 wt. %. The proportion of protein-rich components is preferably between 2 and 30 wt. %, particularly preferably in the range of 4 to 15 wt. %. The proportion of added fat is preferably 0.5 to 10 wt. %, particularly preferably in the range of 1 to 8 wt. % and very particularly preferably from 3 to 6 wt. %, always based on the total weight of the feed. The weight proportions of the feed components must be weighted in such a way that the energy content of the total feed is in the range of 11.4 to 12.9 MJ ME/kg feed.

The energy reduction in the feed can be achieved in different ways. Basically, starting from a high energy feed, one component of the feed can be replaced by a lower energy component to a certain extent.

The reduction in energy can be achieved, for example, by reducing the proportion of added animal or vegetable fat, whereby the proportion by weight of protein-rich, carbohydrate-rich and/or low energy components is increased accordingly. Low energy feeds with a reduced content of added fat preferably have a fat content in the range of 0.5 to 5 wt. %, in particular between 1 and 4.5 wt. %, and particularly preferably between 1 and 3.5 wt. %.

If the energy reduction is achieved by reducing the weight proportion of protein-rich components, the weight proportion of carbohydrate-rich and low energy components is increased. When reducing the protein-rich components in the feed, amino acids from the group of lysine, methionine, threonine, tryptophan and valine are preferably added to the feed, so that the reduction in the energy content of the feed is achieved without an undersupply of amino acids occurring. Such feeds preferably have a proportion of protein-rich components of 2 to 15 wt. %, preferably 3 to 10 wt. %. The proportion of additionally added amino acids is preferably in the range of 0.05 to 5 wt. %, particularly preferably in the range of 0.1 to 2 wt. %.

Furthermore, the low energy feed can have a low proportion of carbohydrate-rich components, which are replaced by low energy components, such as bran in particular.

Preferred are vegetarian diets, which may contain only animal fats as the only animal component, preferably purely vegetarian diets are also fed.

The invention further relates to a feed for pigs comprising i) a composition containing guanidinoacetic acid and ii) a low energy feed for pigs having a crude protein content in the range of 10.0 to 20.0 wt. % based on the total weight of the feed and an energy content in the range of 11.4 to 12.9 MJ ME/kg feed.

The feed is provided in particular for administration during fattening of pigs from a live weight of ≥27 kg per pig, preferably ≥60 kg per pig.

According to the invention, a low energy feed containing the following ingredients has turned out to be particularly advantageous:
a) crude protein in an amount of 14 to 18 wt. %, in particular 16 to 17.5 wt. %,
b) guanidinoacetic acid in an amount of 0.01 to 0.20 wt. %, preferably 0.04 to 0.10 wt. %,
and having a metabolic energy content ME in the range of 11.4 to 12.9 MJ ME/kg feed, preferably of 12.4 to 12.8 MJ ME/kg feed.

Guanidinoacetic acid can be produced, for example, by reacting glycine and cyanamide in an aqueous solution. Guanidinoacetic acid is also commercially available under the name Creamino® (AlzChem Trostberg GmbH).

The invention further relates to a method for improving the energy utilization of a low energy feed by pigs, wherein pigs are administered a low energy feed for pigs with a crude protein content in the range of 10.0 to 20.0 wt. % based on the total weight of the feed and an energy content in the range of 11.4 to 12.9 MJ ME/kg feed during fattening of the pigs from a live weight of ≥27 kg per pig and furthermore a composition comprising guanidinoacetic acid.

The preferred embodiments of the features of the method according to the invention are as set forth hereinbefore.

The following examples are intended to illustrate the present invention.

### EXAMPLES

In a 39-day feeding experiment, three different feed concepts were fed to fattening pigs with an initial weight of ˜65 kg. For each feeding concept, 80 pigs in 16 pens (5 animals per pen) were examined. The pens were exclusively occupied by animals of the same gender, i.e. females or non-castrated boars, in a 1:1 gender ratio.

The three different feed groups were optimized for the content of metabolic energy (ME) and the other raw nutrients based on the supply recommendations of the NRC (National Research Council of the National Academies, 2012: Nutrient requirements of Swine/Committee on Nutrient Requirements of Swine, Board on Agriculture and Natural Resources, Division on Earth and Life Studies.-11th rev. ed. p. cm.). A positive control group with 13.0 MJ ME covering the energy requirements was compared with a negative control group with 12.8 MJ ME reduced by 0.2 MJ. In a guanidinoacetic acid group supplemented with 600 g/t, an energy content of 12.7 MJ ME was adjusted.

The fattening phase lasted 39 days. On day 40, the animals that had already reached the slaughter weight of ˜108 kg were slaughtered. For this reason, data was recorded on this day.

The detailed rations of the three treatments over both feeding phases are shown in Table 1. The rations were based on wheat, wheat semolina bran, rapeseed extraction meal and soy extraction meal. Animal fat was also added in relevant amounts. The diets were isonitrogenous, i.e. the supply of crude protein and digestible amino acids was identical in all three treatment groups.

TABLE 1
Ration composition of the feed fed during the fattening phase

| | Fattening phase | | |
|---|---|---|---|
| Feed component/nutrient | Pos. contr. | Neg. contr. | GAA |
| Wheat (%) | 54.85 | 55.77 | 48.95 |
| Wheat semolina bran (%) | 25.00 | 25.00 | 30.65 |
| Rapeseed extraction meal (38% XP) | 8.00 | 8.00 | 8.00 |
| (%) | | | |
| Soy extraction meal (48% XP) (%) | 5.00 | 5.00 | 5.00 |
| Animal fat (%) | 4.22 | 3.28 | 4.20 |
| Calcium carbonate (%) | 0.95 | 0.97 | 1.09 |
| Monocalcium phosphate (%) | 0.90 | 0.90 | 0.87 |
| Sodium chloride (NaCl, %) | 0.47 | 0.48 | 0.59 |
| L-lysine sulfate (%) | 0.30 | 0.30 | 0.29 |
| Premix (%) | 0.31 | 0.30 | 0.30 |
| Guanidinoacetic acid (%) | 0.00 | 0.00 | 0.06 |

Calculated ingredients

| | | | |
|---|---|---|---|
| Crude protein (%) | 17.1 | 17.2 | 17.2 |
| Crude ash (%) | 5.4 | 5.4 | 5.8 |
| Metabolizable energy (MJ/kg) | 13.0 | 12.8 | 12.7 |

The performance of the three treatment groups is shown in Table 2. At 63.9 kg, the animals in the guanidinoacetic acid group, at the start of the fattening phase, were on average approximately 1.8 kg lighter than the animals in the two control groups. This was due to the randomized allocation of the animals to the experimental groups. On the last day of data collection, the animals weighed a good 96 kg on average. The animals in all groups therefore reached approximately the same average final weight. At the beginning of the fattening phase, the animals in the guanidinoacetic acid group were around 1.8 kg lighter than the two control groups. The resulting daily weight gains of the guanidinoacetic acid group in the fattening phase of approximately 830 g/d were therefore significantly higher than the values of the positive control group at approximately 800 g/d and the negative control group at approximately 800 g/d. The addition of guanidinoacetic acid to a feed with a lower energy content was therefore able to compensate for the energy deficit.

The effect of guanidinoacetic acid was mainly observed in the different daily feed intakes of the three treatment groups. The animals in the positive control group and the GAA group continuously ate approximately the same amount of feed per day. In contrast, the feed intake of the negative control group was generally increased by over 100 g/day. Since the feed intake of pigs is controlled by the energetic status of the animal, this observation is due to the different energy contents of the feeds of the three treatment groups. The energy content of the negative control group was reduced by 0.2 MJ ME. To compensate for this energy deficit, the animals consequently increased their daily feed intake. In terms of daily feed intake, the animals in the GAA group were at the same level as the positive control. The addition of 600 g/t guanidinoacetic acid was therefore able to compensate for the energy deficit of 0.2 MJ ME, although guanidinoacetic acid itself has no significant energy content.

In the fattening phase, a slightly improved feed conversion ratio of 2.69 kg feed/kg weight gain was also observed compared to the positive control by 6 points and 23 points compared to the negative control. This ratio again shows that the animals in the negative control group compensated for the energy deficit by increasing their feed intake in order to maintain their performance level, whereas the animals in the guanidinoacetic acid group were even able to achieve improved performance with less feed. The feed intake of the animals in the guanidinoacetic acid group corresponded to that of the positive control; no increase in feed intake was observed as a result of the administration of guanidinoacetic acid in this example.

The energy utilization of the animals was also improved by the administration of very small amounts of guanidinoacetic acid. The animals in the guanidinoacetic acid group required 2.1 MJ ME (positive control) and 4.3 MJ ME (negative control) less energy per kg gain during the fattening phase. It can be seen that when low energy feed is used in combination with guanidinoacetic acid, the energy utilization of the animals is improved more than the feed conversion of the positive control. In this example, feed conversion only improved by approximately 2.2%, but energy utilization improved by approximately 5.8%.

The results are summarized in Table 2.

TABLE 2

| | Treatment | | |
|---|---|---|---|
| | | | Guanidino- |
| | Positive | Negative | acetic |
| Parameters | contr. | contr. | acid |
| Number of animals (n) | 80 | 79 | 79 |
| Pens (n) | 16 | 16 | 16 |
| Live weight (kg) at the beginning of | 65.6 | 65.8 | 63.9 |
| the fattening phase, day 1 | | | |
| Live weight (kg), day 39 | 96.9 | 96.9 | 96.2 |
| Daily weight gain (g), day 1-39 | 803 | 797 | 828 |
| Daily feed intake (g), day 1-39 | 2211 | 2324 | 2223 |
| Feed conversion (kg feed/kg gain), | 2.75 | 2.92 | 2.69 |
| day 1-39 | | | |
| Energy utilization (MJ ME/kg gain), | 36.3 | 38.5 | 34.2 |
| day 1-39 | | | |
| Average number of fattening days | 52 | 53 | 52 |
| (from the start of the fattening phase) | | | |
| Average slaughter weight (kg) | 108.0 | 107.9 | 107.3 |

Feed conversion is the amount of feed consumed that leads to a weight gain of the animal of one kilogram. Energy utilization is the energy intake per kilogram of weight gain.

The feeding experiment was therefore able to prove that the addition of 600 g/t guanidinoacetic acid to the feed of fattening pigs is sufficient to compensate for an energy deficit of around 0.3 MJ ME/kg. The animals supplied with guanidinoacetic acid achieved comparable, and in some cases even improved, performance compared to the energy requirement-covered positive control and did not change their feed intake. Feed intake is controlled, among other things, by the energetic status of the animals. This was observed in the negative control animals. Although they achieved similar weight gains to the positive control, they had to increase their daily feed intake by over 100 g to do so.

The animals were slaughtered from day 40 to day 74 when they reached a slaughter weight of approximately 108 kg and the diets were maintained. It is also shown herein that the administration of guanidinoacetic acid completely compensated for an energy deficit in the feed of approximately 0.3 MJ ME/kg. The average number of fattening days until slaughter remained the same.

1. Use of i) a composition comprising guanidinoacetic acid and ii) a low energy feed for pigs having a crude protein content in the range of 10.0 to 20.0 wt. % based on a total weight of the feed and an energy content in the range of 11.4 to 12.9 MJ ME/kg feed during fattening of the pigs from a live weight of ≥27 kg per pig, for improving the energy utilization of the feed by the pigs.

2. Use according to claim 1, wherein the improvement in the energy utilization of the feed by the pigs compensates for an energy deficit of at least 0.1 MJ ME/kg compared to a corresponding feed without guanidinoacetic acid.

3. Use according to claim 1, wherein the energy utilization of the feed by the pigs is improved compared to the low energy feed alone.

4. Use according to claim 1, wherein the composition i) is provided as a solid preparation mixed with the feed for the pigs.

5. Use according to claim 1, wherein the composition i) comprises guanidinoacetic acid as free acid or in the form of a salt of this acid.

6. Use according to claim 1, wherein the guanidinoacetic acid is used in the form of a salt of the guanidinoacetic acid, the salt being selected from the group of alkali metal or alkaline earth metal salts of guanidinoacetic acid.

7. Use according to claim 1, wherein the guanidinoacetic acid is used in an amount of from 0.01 to 0.20 wt. % based on the total weight of the feed.

8. Use according to claim 1, wherein the guanidinoacetic acid is used in an amount of from 0.04 to 0.10 wt. % based on the total weight of the feed.

9. Use according to claim 1, wherein the composition i) comprising guanidinoacetic acid and/or the feed ii) comprise amino acids from the group lysine, methionine, threonine, thryptophan, valine or glycine or mixtures thereof as additives.

10. Use according to claim 1, wherein the energy content of the low energy feed ii) is in the range of 12.2 to 12.8 MJ ME/kg feed.

11. Use according to claim 1, wherein the composition comprising guanidinoacetic acid i) is used in combination with the low energy feed ii) in the fattening of the pigs from a live weight of 60 kg.

12. Method for improving the energy utilization of a low energy feed by pigs, wherein pigs are administered a low energy feed for pigs having a crude protein content in the range of 10.0 to 20.0 wt. % based on the total weight of the feed and an energy content in the range of 11.4 to 12.9 MJ ME/kg feed during fattening of the pigs from a live weight of ≥27 kg per pig and further a composition containing guanidinoacetic acid.

13. Method according to claim 12, wherein the improvement of the energy utilization of the feed by the pigs compensates for an energy deficit of at least 0.1 MJ ME/kg compared to a corresponding feed without guanidinoacetic acid.

14. Method according to claim 12, wherein the energy utilization of the feed by the pigs is improved compared to the low energy feed alone.

15. Method according to claim 12, wherein the composition i) is provided as a solid preparation mixed with the feed for the pigs.

16. Method according to claim 12, wherein the composition i) comprises guanidinoacetic acid as a free acid or in the form of a salt of this acid.

17. Method according to claim 12, wherein the guanidinoacetic acid is used in the form of a salt of the guanidinoacetic acid, the salt being selected from the group of alkali metal or alkaline earth metal salts of guanidinoacetic acid.

18. Method according to claim 12, wherein the guanidinoacetic acid is used in an amount of from 0.01 to 0.20 wt. % based on the total weight of the feed.

19. Method according to claim 12, wherein the guanidinoacetic acid is used in an amount of from 0.04 to 0.10 wt. % based on the total weight of the feed.

20. The method according to claim 12, wherein the composition i) comprising guanidinoacetic acid and/or the feed ii) comprise amino acids from the group lysine, methionine, threonine, thryptophan, valine or glycine or mixtures thereof as additives.

21. The method according claim 12, wherein the energy content of the low energy feed ii) is in the range of 12.2 to 12.8 MJ ME/kg feed.

22. The method according to claim 12, wherein the composition comprising guanidinoacetic acid i) is used in combination with the low energy feed ii) in the fattening of the pigs from a live weight of 60 kg, preferably at a live weight of >60 kg up to a live weight of 110 kg.

23. Feed for pigs comprising:
i) a composition comprising guanidinoacetic acid; and
ii) a low energy feed for pigs having a crude protein content in the range of 10.0 to 18.0 wt. % based on the total weight of the feed and an energy content in the range of 11.4 to 12.9 MJ ME/kg feed.

24. Feed for pigs according to claim 23 for administration during fattening of the pigs from a live weight of ≥27 kg per pig.

25. Feed according to claim 23 for improving the energy utilization of the feed by the pigs.

26. Feed according to claim 23, wherein the low energy feed has a crude protein content in the range of 14 to 18 wt. % based on the total weight of the feed, and an energy content in the range of 11.4 to 12.9 MJ ME/kg of feed, and
guanidinoacetic acid in an amount of 0.01 to 0.20 wt. % based on the total weight of the feed.
